(19) United States
(12) Patent Application Publication
(10) Pub. No.: US 2010/0205241 A1
(43) Pub. Date: Aug. 12, 2010

(54) METHOD AND SYSTEM FOR DOWNLOADING NETWORK DATA INTO MULTIMEDIA PLAYER

(75) Inventors: Yung-Yu Lin, Taichung City (TW); Shih-Ting Ou Yang, Hsinchu County (TW); Yu-Chi Chen, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: SUNPLUS TECHNOLOGY CO., LTD., Hsinchu (TW)

(21) Appl. No.: 12/429,187

(22) Filed: Apr. 24, 2009

(30) Foreign Application Priority Data
Feb. 12, 2009 (TW) 98104489

(51) Int. Cl. G06F 15/16

(52) U.S. Cl. 709/203

(57) ABSTRACT

A method and a system for downloading network data into a multimedia player are provided. In the present method, a data getting instruction sent by the multimedia player is received and accordingly a webpage source code is captured. Then, a web server corresponding to the webpage source code is identified, and the webpage source code is parsed according to a type information of the web server to obtain a plurality of data url links conforming to a data attribute. Finally, network data corresponding to each of the data url links is downloaded through a network and provided to the multimedia player.

### CROSS-REFERENCE TO RELATED APPLICATION

This application claims the priority benefit of Taiwan application serial No. 98104489, filed on Feb. 12, 2009. The entirety of the above-mentioned patent application is hereby incorporated by reference herein and made a part of this specification.

### BACKGROUND OF THE INVENTION

1. Field of the Invention

The present invention generally relates to an application about network data, and more particularly, to a method and a system for downloading network data.

2. Description of Related Art

Along with the advancement of image sensor devices, digital signal processing techniques, and optical systems, digital camera has become one of the most indispensable equipments in our daily life due to its easy operation, slim appearance, and low cost. The major difference between a digital camera and a conventional camera is that the film processing procedure in the conventional camera is omitted in the digital camera and a user can directly view photos taken by the digital camera. Besides, the digital photos taken by a digital camera are directly stored into a memory card or a computer hard disk. Thereby, the cost of film processing is saved, and the photos can be stored for a long time.

Along with the invention of online photo albums, users have become accustomed to uploading their photos into online photo albums to share the photos with family and friends. However, a user can only browse the photos in an online photo album by connecting to the Internet through a computer. In order to allow the users to view digital photos in online photo albums without having to turn on a computer system, digital photo frames especially designed for displaying digital photos have been invented and gradually accepted by the users.

An early digital photo frame only has a card reader module and accordingly can only access and display local digital photos. After the digital photo frames are integrated with the network connection function, a digital photo frame can connect to an online photo album and display the photos in the online photo album through a browser. However, since the browser has to be executed by an operating system, the system complexity of the digital photo frame is increased. Meanwhile, in order to support a complete browser application program, hardware devices of a higher standard have to be adopted and accordingly the hardware cost of the digital photo frame is increased.

In addition, another kind of apparatuses for browsing photos in online photo albums is limited to displaying the photos in the online photo albums on some specific websites. In other words, such an apparatus can only connect to a specific online album server, and a user cannot browse photos in online photo albums provided by other websites through this apparatus, which is very inconvenient to the user.

### SUMMARY OF THE INVENTION

Accordingly, the present invention is directed to a multimedia player which can download network data and a method for downloading network data by using the multimedia player, wherein network data can be conveniently downloaded and browsed by using the multimedia player which comes without any network connection function or browser.

The present invention is directed to a system for downloading network data, wherein appropriate network data is downloaded and stored according to different hardware specification regardless of the type of a web server, so that the flexibility in accessing network data is improved.

The present invention provides a method for downloading network data into a multimedia player. First, a data getting instruction issued by the multimedia player is received, and then a webpage source code is captured through a network. Next, a web server corresponding to the webpage source code is identified, and the webpage source code is parsed according to a type information of the web server to obtain a plurality of data url links conforming to a data attribute. Finally, the network data corresponding to each data url link is downloaded through the network, and the network data is provided to the multimedia player.

According to an embodiment of the present invention, after the step of receiving the data getting instruction, the method further includes performing a Hypertext Transfer Protocol (HTTP) format data packaging procedure to the data getting instruction.

According to an embodiment of the present invention, the step of capturing the webpage source code includes providing a webpage link and connecting to the web server corresponding to the webpage link through the network to capture the webpage source code of the webpage link, wherein the webpage link includes a Really Simple Syndication (RSS) feed link.

According to an embodiment of the present invention, the step of capturing the webpage source code further includes obtaining the webpage source code recorded in a local storage medium within the multimedia player.

According to an embodiment of the present invention, before the step of identifying the web server corresponding to the webpage source code, the method further includes performing an HTTP format data extraction procedure to the captured webpage source code.

According to an embodiment of the present invention, the data attribute includes a specific file type and a specific file information, wherein the specific file type includes an image file and a text file, and the specific file information includes a file size, a file character, a file creation time, and a file update time, etc.

According to an embodiment of the present invention, the step of obtaining the data url links conforming to the data attribute includes obtaining a tag name corresponding to the specific file type according to the type information of the web server and searching for the tag name in the webpage source code to obtain all the data url links conforming to the specific file type.

According to an embodiment of the present invention, after the step of obtaining all the data url links conforming to the specific file type, the method further includes filtering the data url links conforming to the specific file information from all the data url links conforming to the specific file type.

According to an embodiment of the present invention, the step of filtering the data url links conforming to the specific file information from all the data url links conforming to the specific file type includes: obtaining the tag name corresponding to the specific file information; searching for the tag name in the webpage source code to obtain a file information content corresponding to each of the data url links; and when the file information content corresponding to one of the data url links conforms to a specific condition, determining that the data url link conforms to the specific file information.

According to an embodiment of the present invention, the step of filtering the data url links conforming to the specific file information from all the data url links conforming to the specific file type includes: connecting to one of the data url links to obtain a network access header; obtaining the file information content of the data url link corresponding to the specific file information through the network access header; and when the file information content conforms to the specific condition, determining that the data url link conforms to the specific file information, wherein the network access header includes an HTTP header or a file format header.

According to an embodiment of the present invention, the step of providing the network data to the multimedia player includes storing the network data into the local storage medium within the multimedia player.

According to an embodiment of the present invention, the step of providing the network data to the multimedia player also includes directly storing the network data into a memory within the multimedia player to play the network data instantly.

According to an embodiment of the present invention, after the step of obtaining the data url links conforming to the data attribute, the method further includes storing the data url links into the local storage medium within the multimedia player.

According to an embodiment of the present invention, the webpage source code includes a webpage source code in a Hypertext Markup Language (HTML) format or a webpage source code in an Extensible Markup Language (XML) format.

The present invention further provides a system for downloading network data. The system includes a webpage source code parsing module, an HTTP format processing module, and a network communication module with a Transmission Control Protocol/Internet Protocol (TCP/IP) network connection function. The webpage source code parsing module identifies a web server which provides a webpage source code and parses the webpage source code according to a type information of the web server to obtain a plurality of data url links conforming to a data attribute. The HTTP format processing module executes an HTTP format data packaging procedure and an HTTP format data extraction procedure. The network communication module carries out online accesses by using a TCP/IP network stack. When the HTTP format processing module receives a data getting instruction sent by a multimedia player through the webpage source code parsing module, the HTTP format processing module performs the HTTP format data packaging procedure to the data getting instruction and triggers the network communication module to capture a webpage source code through a network. When the HTTP format processing module receives the webpage source code sent back by the network communication module, the HTTP format processing module performs the HTTP format data extraction procedure to the webpage source code and then the webpage source code parsing module obtains the data url links accordingly. The HTTP format processing module and the network communication module download network data corresponding to each of the data url links through the network. Finally, the network data is provided to the multimedia player.

According to an embodiment of the present invention, the webpage source code parsing module receives a webpage link and connects to a web server corresponding to the webpage link via the HTTP format processing module and the network communication module to capture the webpage source code of the webpage link through the network; or the webpage source code parsing module directly obtains the webpage source code from a local storage medium in the multimedia player, wherein the webpage link includes an RSS feed link.

According to an embodiment of the present invention, the webpage source code parsing module further includes a plurality of first type parsers, and each of the first type parsers is corresponding to a different web server. The webpage source code parsing module controls the corresponding first type parser to obtain a tag name corresponding to a specific file type according to a type information of the web server which provides the webpage source code and searches for the tag name in the webpage source code to obtain all the data url links conforming to the specific file type.

According to an embodiment of the present invention, the webpage source code parsing module further includes a plurality of second type parsers, and each of the second type parsers is corresponding to a different specific file information. The webpage source code parsing module controls the corresponding second type parser to filter the data url links conforming to the specific file information from all the data url links conforming to the specific file type according to a type of the specific file information.

According to an embodiment of the present invention, each of the second type parsers obtains the tag name corresponding to the specific file information and searches for the tag name in the webpage source code to obtain a file information content corresponding to each of the data url links, and when the file information content corresponding to one of the data url links conforms to a specific condition, the second type parser determines that the data url link conforms to the specific file information.

According to an embodiment of the present invention, the webpage source code parsing module controls the HTTP format processing module and the network communication module to connect to one of the data url links through the network and obtains a network access header of the connected data url link through the HTTP format data extraction procedure. Each of the second type parsers obtains the file information content of the data url link corresponding to the specific file information according to the network access header, and when the file information content conforms to the specific condition, the second type parser determines that the data url link conforms to the specific file information. The network access header includes an HTTP header and a file format header.

According to an embodiment of the present invention, the webpage source code parsing module stores the network data and the data url links into a local storage medium within the multimedia player.

According to an embodiment of the present invention, the webpage source code includes a webpage source code in a HTML format or a webpage source code in an XML format.

According to an embodiment of the present invention, the multimedia player does not have a network connection function, and the multimedia player is suitable for playing the network data or the data url links provided by the present system.

According to the present invention, a webpage source code is parsed according to the type information of a web server to obtain all the desired data url links without adopting any browser, and the desired network data is then downloaded and provided to a multimedia player which does not have any network connection function. Accordingly, the complexity of the multimedia player will not be increased in order to browse the network data. Moreover, according to the present invention, network data in different web servers can be accessed. Accordingly, the flexibility in downloading network data is increased.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a system for downloading network data according to an embodiment of the present invention.

FIG. 2 is a flowchart of a method for downloading network data into a multimedia player according to an embodiment of the present invention.

FIG. 3 is a flowchart illustrating how to filter data url links according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

If a multimedia player without a network connection function can be used for downloading network data based on the concept of an add-on system without altering the original hardware structure thereof, the flexibility and scalability of the multimedia player in downloading network data will be improved without increasing the hardware cost thereof. Embodiments of the present invention will be described below with reference to accompanying drawings.

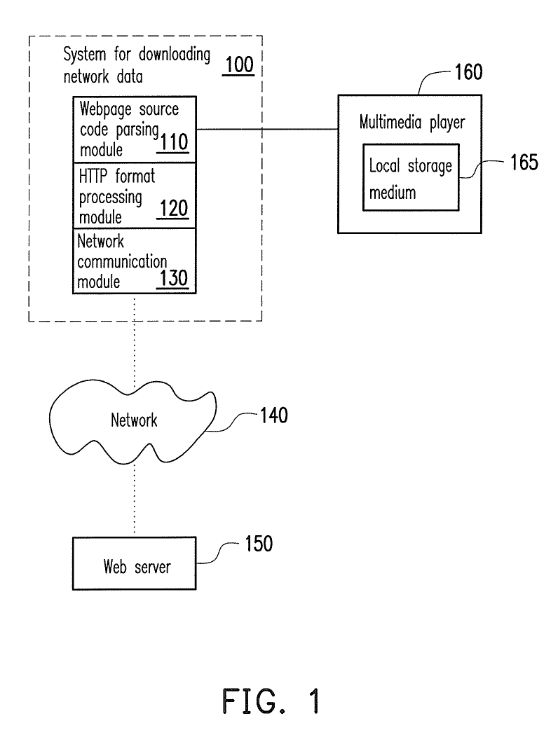

FIG. 1 is a diagram of a system for downloading network data according to an embodiment of the present invention. Referring to FIG. 1, the network data downloading system 100 includes a webpage source code parsing module 110, a Hypertext Transfer Protocol (HTTP) format processing module 120, and a network communication module 130. In the present embodiment, the network data downloading system 100 can be integrated with a multimedia player 160. The multimedia player 160 may be any device which does not have a network connection function, such as a digital photo frame (DPF), a DVD player, a digital set-top box, or a portable electronic device, and the type of the multimedia player 160 is not limited herein.

In the network data downloading system 100, the webpage source code parsing module 110 receives a webpage link and connects to a web server corresponding to the webpage link through the network HTTP format processing module 120 and the network communication module 130 to capture a webpage source code of the webpage link. Or, the webpage source code parsing module 110 can also obtain the webpage source code directly from a local storage medium 165 in the multimedia player 160. The webpage link includes a Really Simple Syndication (RSS) feed link. To be more specific, the webpage source code parsing module 110 identifies the web server which provides the webpage source code and parses the webpage source code according to a type information of the web server to select all the data url links conforming to a data attribute. In the present embodiment, the data attribute includes a specific file type and a specific file information, wherein the specific file type includes an image file and a text file, and the specific file information includes a file size, a file character, a file creation time, and a file update time, etc. The webpage source code parsing module 110 includes a plurality of first type parsers (not shown) and a plurality of second type parsers (not shown) for selecting appropriate data url links according to the specific file type and the specific file information.

To be specific, each first type parser in the webpage source code parsing module 110 is corresponding to a different web server and can be used for parsing the webpage source code provided by the web server and finding out all the data url links conforming to a specific file type from the webpage source code. Each second type parser in the webpage source code parsing module 110 is corresponding to a different specific file information and can be used for selecting and filtering the appropriate data url links according to the corresponding specific file information.

In an embodiment of the present invention, the webpage source code is corresponding to a webpage link, wherein the webpage link may be a webpage link of any website or an RSS feed link of a website. The webpage source code may be a webpage source code in a Hypertext Markup Language (HTML) format or a webpage source code in an Extensible Markup Language (XML) format, and the scope of the webpage source code is not limited herein. In another embodiment of the present invention, the webpage source code may be recorded in the local storage medium 165 of the multimedia player 160.

The HTTP format processing module 120 executes an HTTP format data packaging procedure and an HTTP format data extraction procedure to package and extract network data in HTTP format. The network communication module 130 offers a Transmission Control Protocol/Internet Protocol (TCP/IP) network connection function and which can connect to and access a network 140 by using a TCP/IP network stack.

In general, even though the multimedia player 160 itself does not have a network connection function, the multimedia player 160 can obtain all the network data conforming to a specific requirement as long as it is integrated with the network data downloading system 100.

Below, the detailed operations of the network data downloading system 100 will be described with reference to another embodiment of the present invention. To make the description clear, herein the multimedia player 160 is assumed to be a digital photo frame, the network data to be downloaded is a photo in an online album, and the photo is stored as a Joint Photographic Experts Group (JPEG) file.

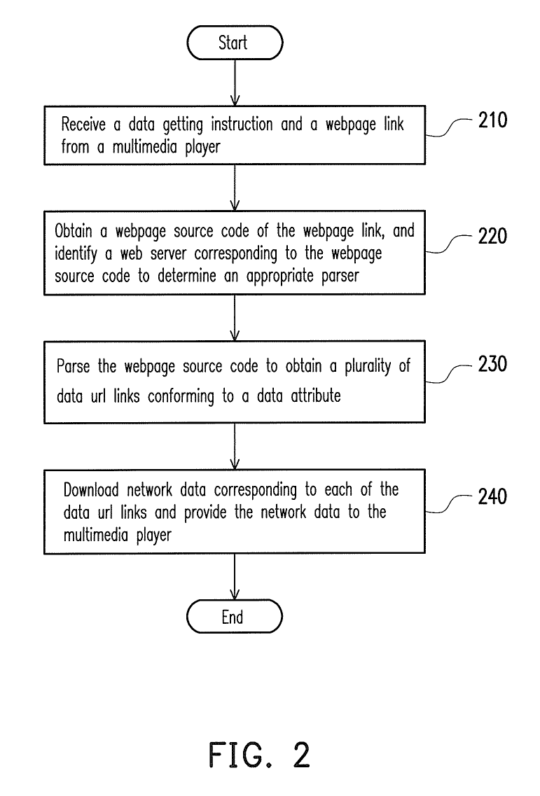

FIG. 2 is a flowchart of a method for downloading network data into a multimedia player according to an embodiment of the present invention. Referring to both FIG. 1 and FIG. 2, in an embodiment of the present invention, when a user of the multimedia player 160 wants to download one or more photos in a specific webpage link, the user can make the multimedia player 160 to issue a data getting instruction (for example, an HTTP GET instruction) by pressing down a button on the multimedia player 160 and send the aforementioned webpage link and the data getting instruction together to the network data downloading system 100. In another embodiment of the present invention, the multimedia player 160 may also issue the data getting instruction and the webpage link spontaneously at a fixed time.

In step 210, the webpage source code parsing module 110 receives the data getting instruction and the webpage link, and the HTTP format processing module 120 performs an HTTP format data packaging procedure to the data getting instruction and the webpage link and triggers the network communication module 130 to connect to the network 140, so as to capture the corresponding webpage source code, wherein the webpage link may be the homepage link corresponding to a specific account in an online album or an RSS feed link corresponding to the specific account.

After it is determined that the webpage link does exist, in step 220, the network communication module 130 connects to a web server (for example, a web server 150) corresponding to the webpage link to capture the webpage source code of the webpage link. To be specific, the network communication module 130 first connects to the web server 150 which provides the online album service and then captures the webpage source code of the webpage link corresponding to a specific account. It has to be noted that regardless of whether the webpage link provided by the user is a homepage link or an RSS feed link, to the network data downloading system 100, the captured webpage source code is always a file composed of many HTML tags or XML tags. After the network communication module 130 captures the webpage source code, it sends the webpage source code upwards to the webpage source code parsing module 110 through the HTTP format processing module 120. The webpage source code parsing module 110 then selects a parser which is most suitable for parsing the webpage source code among all the first and second type parsers according to a type information of the web server 150 which provides the webpage source code.

Next, in step 230, the webpage source code parsing module 110 parses the webpage source code by using the parser and selects all the data url links conforming to a data attribute (i.e., a specific file type and a specific file information). In other words, in this step, all the photo storage links conforming to a specific requirement are selected from the online photo album.

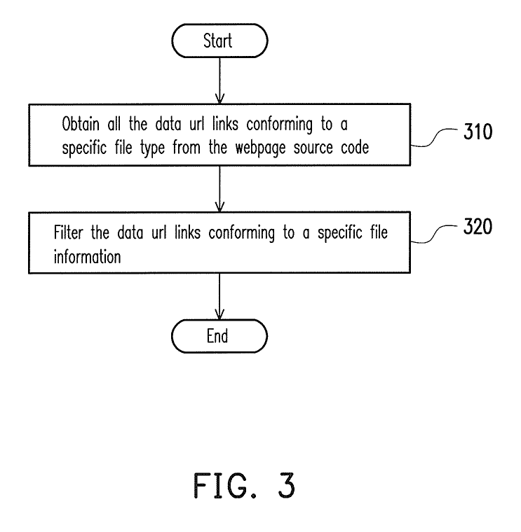

FIG. 3 is a flowchart illustrating how to filter the data url links according to an embodiment of the present invention. Referring to FIG. 3, since each online photo album service provider has its own web server and different webpage source code format or tag names, in order to parse the webpage source code according to different service provider, the webpage source code parsing module 110 first identifies a type information of the web server which provides the webpage source code. Then, in step 310, the webpage source code parsing module 110 controls a first type parser relative to the web server to obtain the tag name of the specific file type. Thereafter, the webpage source code parsing module 110 searches for the tag name in the webpage source code to obtain all the data url links conforming to the specific file type, wherein the specific file type may be any image file or text file, and the scope thereof is not limited herein. In the present embodiment, because the data to be downloaded is a photo in JPEG format, the specific file type is JPEG file. Accordingly, to find out all the data url links conforming to the JPEG file format, the webpage source code parsing module 110 controls the corresponding first type parser to obtain the tag name corresponding to the JPEG file and then searches for the tag name in the webpage source code to obtain all the data url links conforming to the JPEG file format.

Next, in step 320, the webpage source code parsing module 110 further controls a second type parser to filter the data url links conforming to the specific file information among all the data url links conforming to the JPEG file format. In the present embodiment, the specific file information comprises at least one of a file size, a file character, a file creation time, or a file update time. The webpage source code parsing module 110 controls the second type parser according to a user requirement or the hardware restriction of the multimedia player 160 to filter the data url links by using the tag name in the webpage source code or the network access header obtained by connecting to the data url link.

To be specific, because the webpage source code has been captured into the network data downloading system 100, the desired data url links can be obtained quickly by selecting the data url links according to the webpage source code. The second type parser determined by the webpage source code parsing module 110 directly searches for the tag name corresponding to the specific file information in the webpage source code and accordingly obtains the file information content corresponding to each of the data url links. If the file information content corresponding to a data url link conforms to a specific condition, the data url link is determined to be conforming to the specific file information.

In addition, a corresponding network access header (for example, an HTTP header or a file format header) can be obtained when linking to a data url link. The network access header may also contain various file information. Accordingly, the webpage source code parsing module 110 may control the HTTP format processing module 120 and the network communication module 130 to link the data url link through the network 140 and obtain the network access header of the connected data url link through the HTTP format data extraction procedure performed by the HTTP format processing module 120. After that, a file information content of the data url link corresponding to the specific file information is obtained according to the network access header through the determined second type parser, and the data url link is determined to be conforming to the specific file information when the file information content conforms to the specific condition.

For the convenience of description, herein it is assumed that the webpage source code parsing module 110 includes three second type parsers which are respectively a second type parser A, a second type parser B, and a second type parser C, wherein the three second type parsers are respectively corresponding to the specific file information of file size, file character, and file creation time. In an embodiment of the present invention, it is assumed that only those JPEG files whose sizes are not more than a specific condition (for example, 500K) can be downloaded and stored due to the volume limitation of the local storage medium 165 in the multimedia player 160. In this case, the webpage source code parsing module 110 selects and controls the second type parser A to obtain a tag name (for example, <size>) corresponding to the file size and searches for the tag name <size> in the webpage source code to obtain the sizes of the JPEG files corresponding to the data url links and delete those data url links having their sizes over 500K. Namely, through the selection of the second type parser A, the remaining data url links are all corresponding to JPEG files having their sizes less than 500K.

In another embodiment of the present invention, besides filtering the data url links according to their file sizes, the appropriate data url links may also be selected according to their file characters. For example, the webpage source code parsing module 110 selects and controls the second type parser B to obtain the tag name (for example, <variety>) corresponding to the file character and searches for the tag name <variety> in the webpage source code. The content after this tag name indicates whether the JPEG file corresponding to the data url link belongs to an original image type or a thumbnail. Assuming the specific condition is the thumbnail, the second type parser B deletes all those data url links corresponding to the original image type and keeps only those data url links conforming to the thumbnail.

In yet another embodiment of the present invention, in order to avoid capturing an outdated network data, the webpage source code parsing module 110 selects and controls the second type parser C to filter the data url links having their file creation time conforming to a specific condition (for example, within last three months) among all the data url links corresponding to the JPEG file format. To be specific, after connecting to the data url links to obtain the network access headers (for example, HTTP headers or JPEG headers), the second type parser C obtains the file creation time from the network access headers and deletes those data url links having their file creation time over three months, so as to select only those data url links created within last three months.

As shown in FIG. 3, through the operations of the first and second type of parsers in the webpage source code parsing module 110, all the data url links conforming to the specific file type and the specific file information can be selected from the webpage source code. Next, referring to FIG. 2 again, in step 240, the HTTP format processing module 120 and the network communication module 130 connect to the network 140 again and download the network data corresponding to each data url link (i.e., photos in JPEG format and conforming to the specific file information) from the web server 150 and provide the network data to the multimedia player 160 to be stored into the local storage medium 165. In an embodiment of the present invention, the network data downloading system 100 may store the downloaded part of the network data into the local storage medium 165 while it is still downloading the network data. In another embodiment of the present invention, the network data downloading system 100 may store the network data into the local storage medium 165 after completely downloading the network data.

It should be mentioned that because the multimedia player 160 may be disposed with different storage media at the same time, such as a memory card, a USB device, or a flash memory, the network data downloading system 100 first determines which storage medium (for example, the memory card) the network data is to be stored and then stores the obtained data url links and the corresponding network data into the selected storage medium.

In another embodiment of the present invention, the second type parsers in the webpage source code parsing module 110 can categorize all the data url links conforming to the JPEG file format into a thumbnail and an original image type according to the file character. In the case that the local storage medium 165 has a small capacity and accordingly can only store thumbnails, those JPEG files corresponding to the thumbnail are downloaded and stored into the local storage medium 165, and besides, those data url links belonging to the original image type are also stored into the storage unit. After that, when the multimedia player 160 displays all the JPEG files conforming to the thumbnail, the data url links corresponding to the original image type are also displayed. Accordingly, after the user browses the thumbnails, the user can control the network data downloading system 100 to capture a clearer original image file according to the data url link corresponding to the original image type.

It has to be noted that even though foregoing embodiment is described with the example of downloading photos in JPEG format from an online photo album, the multimedia player 160 which does not have a network connection function can be used for downloading any other network data of any file type (such as image files or text files) through the operation of the network data downloading system 100 and the same or a similar procedure as shown in FIG. 2.

In overview, the present invention provides a method and a system for downloading network data in a multimedia player, wherein after connecting to a network and capturing a webpage source code, data url links are selected according to different user requirement or hardware restriction, and appropriate network data is then downloaded and stored. Thereby, even though the multimedia player does not have a network connection function, it can also obtain various network data from the Internet. Moreover, parsers for parsing the webpage source code are respectively designed regarding different web servers such that the network data to be downloaded is not limited to the network data of a particular web server. Thereby, the flexibility and convenience in downloading network data are improved, and meanwhile, since no browser or operating system is required, the hardware cost of the multimedia player is greatly reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for downloading network data into a multimedia player, comprising:
receiving a data getting instruction issued by the multimedia player to capture a webpage source code through a network;
identifying a web server corresponding to the webpage source code;
parsing the webpage source code according to a type information of the web server to obtain a plurality of data url links conforming to a data attribute; and
downloading a network data corresponding to each of the data url links through the network, and providing the network data to the multimedia player.

2. The method according to claim 1, wherein after the step of receiving the data getting instruction, the method further comprises:
performing a Hypertext Transfer Protocol (HTTP) format data packaging procedure to the data getting instruction.

3. The method according to claim 1, wherein the step of capturing the webpage source code comprises:
providing a webpage link; and
connecting to the web server corresponding to the webpage link through the network to obtain the webpage source code of the webpage link.

4. The method according to claim 3, wherein the webpage link comprises a Really Simple Syndication (RSS) feed link.

5. The method according to claim 1, wherein the step of capturing the webpage source code comprises:
obtaining the webpage source code recorded in a local storage medium within the multimedia player.

6. The method according to claim 1, wherein before the step of identifying the web server corresponding to the webpage source code, the method further comprises:
performing an HTTP format data extraction procedure to the captured webpage source code.

7. The method according to claim 1, wherein the data attribute comprises a specific file type and a specific file information; the specific file information comprises a file size, a file character, a file creation time, and a file update time; and the specific file type comprises a image file and a text file.

8. The method according to claim 7, wherein the step of parsing the webpage source code according to the type information of the web server to obtain the data url links conforming to the data attribute comprises:
obtaining a tag name corresponding to the specific file type according to the type information of the web server; and
searching for the tag name in the webpage source code to obtain all the data url links conforming to the specific file type.

9. The method according to claim 8, wherein after the step of obtaining all the data url links conforming to the specific file type, the method further comprises:
filtering the data url links conforming to the specific file information from all the data url links conforming to the specific file type.

10. The method according to claim 9, wherein the step of filtering the data url links conforming to the specific file information from all the data url links conforming to the specific file type comprises:
obtaining the tag name corresponding to the specific file information;
searching for the tag name in the webpage source code to obtain a file information content corresponding to each of the data url links; and
when the file information content corresponding to one of the data url links conforms to a specific condition, determining that the data url link conforms to the specific file information.

11. The method according to claim 9, wherein the step of filtering the data url links conforming to the specific file information from all the data url links conforming to the specific file type comprises:
connecting to one of the data url links to obtain a network access header;
obtaining a file information content of the data url link corresponding to the specific file information through the network access header; and
when the file information content conforms to a specific condition, determining that the data url link conforms to the specific file information.

12. The method according to claim 11, wherein the network access header comprises an HTTP header and a file format header.

13. The method according to claim 1, wherein the step of providing the network data to the multimedia player comprises:
storing the network data into a local storage medium within the multimedia player.

14. The method according to claim 1, wherein after the step of obtaining the data url links conforming to the data attribute, the method further comprises:
storing the data url links into a local storage medium within the multimedia player.

15. The method according to claim 1, wherein the webpage source code comprises one of a webpage source code in a Hypertext Markup Language (HTML) format and a webpage source code in an Extensible Markup Language (XML) format.

16. A system for downloading network data, comprising:
a webpage source code parsing module, for identifying a web server which provides a webpage source code and parsing the webpage source code according to a type information of the web server to obtain a plurality of data url links conforming to a data attribute;
an HTTP format processing module, for executing an HTTP format data packaging procedure and an HTTP format data extraction procedure; and
a network communication module, for connecting to a network by using a Transmission Control Protocol/Internet Protocol (TCP/IP) network stack,
wherein when the HTTP format processing module receives a data getting instruction sent by a multimedia player through the webpage source code parsing module, the HTTP format processing module performs the HTTP format data packaging procedure to the data getting instruction and triggers the network communication module to capture the webpage source code through the network,
when the HTTP format processing module receives the webpage source code sent back by the network communication module, the HTTP format processing module performs the HTTP format data extraction procedure to the webpage source code and then the webpage source code parsing module obtains the data url links accordingly, and the HTTP format processing module and the network communication module download a network data corresponding to each of the data url links through the network and provide the network data to the multimedia player.

17. The system according to claim 16, wherein the webpage source code parsing module receives a webpage link and connects to the web server corresponding to the webpage link via the HTTP format processing module and the network communication module to obtain the webpage source code of the webpage link through the network.

18. The system according to claim 17, wherein the webpage link comprises an RSS feed link.

19. The system according to claim 16, wherein the multimedia player further comprises a local storage medium, and the webpage source code parsing module obtains the webpage source code recorded in the local storage medium.

20. The system according to claim 16, wherein the data attribute comprises a specific file type and a specific file information, the specific file information comprises a file size, a file character, a file creation time, and a file update time, and the specific file type comprises an image file and a text file.

21. The system according to claim 19, wherein the webpage source code parsing module further comprises:
a plurality of first type parsers, wherein each of the first type parsers is corresponding to a different one of the web server, the webpage source code parsing module controls the corresponding first type parser to obtain a tag name corresponding to the specific file type and searches for the tag name in the webpage source code to obtain all the data url links conforming to the specific file type according to a type information of the web server which provides the webpage source code.

22. The system according to claim 21, wherein the webpage source code parsing module further comprises:
a plurality of second type parsers, wherein each of the second type parsers is corresponding to a different one of the specific file information, the webpage source code parsing module controls the corresponding second type parser to filter the data url links conforming to the specific file information from all the data url links conforming to the specific file type according to a type of the specific file information

23. The system according to claim 22, wherein each of the second type parsers obtains the tag name corresponding to the specific file information, searches for the tag name in the webpage source code to obtain a file information content corresponding to each of the data url links, and when the file information content corresponding to one of the data url links conforms to a specific condition, the second type parser determines that the data url link conforms to the specific file information.

24. The system according to claim 22, wherein the webpage source code parsing module controls the HTTP format processing module and the network communication module to connect to one of the data url links through the network and obtains a network access header of the connected data url link through the HTTP format data extraction procedure, and each of the second type parsers obtains a file information content of the data url link corresponding to the specific file information according to the network access header and when the file information content conforms to a specific condition, determines that the data url link conforms to the specific file information.

25. The system according to claim 24, wherein the network access header comprises an HTTP header and a file format header.

26. The system according to claim 16, wherein the webpage source code parsing module stores the network data into a local storage medium within the multimedia player.

27. The system according to claim 16, wherein the webpage source code parsing module stores the data url links into a local storage medium within the multimedia player.

28. The system according to claim 16, wherein the webpage source code comprises a webpage source code in a HTML format and a webpage source code in a XML format.

29. The system according to claim 16, wherein the multimedia player does not have a network connection function.

30. The system according to claim 16, wherein the multimedia player is used for playing the network data or the data url links provided by the system.
